(19) United States
(12) Patent Application Publication
(10) Pub. No.: US 2026/0342367 A1
(43) Pub. Date: Oct. 29, 2026

(54) RADIO-FREQUENCY MODULE AND COMMUNICATION DEVICE INCLUDING THE SAME

(71) Applicant: Murata Manufacturing Co., Ltd., Nagaokakyo-shi (JP)

(72) Inventors: Kenji TAHARA, Nagaokakyo-shi (JP); Kae YAMAMOTO, Nagaokakyo-shi (JP)

(73) Assignee: Murata Manufacturing Co., Ltd., Nagaokakyo-shi (JP)

(21) Appl. No.: 19/710,422

(22) Filed: Jun. 17, 2026

Related U.S. Application Data
(63) Continuation of application No. PCT/JP2025/002633, filed on Jan. 28, 2025.

(30) Foreign Application Priority Data
Mar. 1, 2024 (JP) 2024-031229

(51) Int. Cl. H04B 1/04; H04B 1/12; H04B 1/16

(52) U.S. Cl. CPC H04B 1/04; H04B 1/12; H04B 1/16

(57) ABSTRACT

A radio-frequency module includes a first terminal receiving a transmit signal, a second terminal connected to an antenna, a third terminal outputting a received signal, a transmit circuit, a receive line supplying the received signal to the third terminal, and a hybrid coupler. The transmit circuit includes first and second amplifier circuits. The hybrid coupler includes first to fourth lines connected in a loop. A first node between the first and second lines connects to an output of the first amplifier circuit. A second node between the first and third lines connects to an output of the second amplifier circuit. A third node between the second and fourth lines connects to the second terminal. A fourth node between the third and fourth lines connects to the receive line. During transmission, the second node receives a signal phase advanced 90° relative to a signal supplied to the first node.

### CROSS-REFERENCE TO RELATED APPLICATIONS

This application is a continuation of International Application No. PCT/JP2025/002633, filed Jan. 28, 2025, which claims priority to Japanese Application No. 2024-031229, filed Mar. 1, 2024, the entire contents of each of which are incorporated herein by reference.

### TECHNICAL FIELD

The present disclosure relates to a radio-frequency module and a communication device including the same. More specifically, the present disclosure relates to a technology for providing isolation between a transmit circuit and a receive circuit in a communication circuit that performs transmission and reception using a common radiating element.

### BACKGROUND ART

U.S. Pat. No. 10,715,204 (Patent Document 1) discloses an electronic device that transmits and receives radio-frequency (RF) waves using a common radiating element. In the electronic device in Patent Document 1, a power amplifier for transmission and a low-noise amplifier for reception are provided for a common antenna, and a switch selects between a transmit circuit and a receive circuit.

### CITATION LIST

### Patent Document

Patent Document 1: U.S. Pat. No. 10,715,204

### SUMMARY

A radio-frequency module according to the present disclosure is configured to transmit and receive radio-frequency signals through an antenna. The radio-frequency module includes a first terminal configured to receive a transmit signal, a second terminal configured to be connected to the antenna, a third terminal configured to output a radio-frequency signal received from the antenna, a transmit circuit, a receive circuit, and a hybrid coupler. The transmit circuit includes a first amplifier circuit and a second amplifier circuit, the first amplifier circuit and the second amplifier circuit being configured to amplify a signal received through the first terminal. The receive circuit includes a receive line configured to deliver a signal received by the antenna to the third terminal. The hybrid coupler is connected to the transmit circuit, the receive circuit, and the second terminal. The hybrid coupler includes a first line, a second line, a third line, and a fourth line connected in a loop. A first connection node between the first line and the second line is connected to an output terminal of the first amplifier circuit. A second connection node between the first line and the third line is connected to an output terminal of the second amplifier circuit. A third connection node between the second line and the fourth line is connected to the second terminal. A fourth connection node between the third line and the fourth line is connected to the receive line.

### BRIEF DESCRIPTION OF DRAWINGS

FIG. 1 schematically illustrates a configuration of a communication device including a radio-frequency module according to a first embodiment.

FIG. 2 illustrates a configuration of a power amplifier circuit in FIG. 1 during transmission.

FIG. 3 illustrates a configuration of the power amplifier circuit in FIG. 1 during reception.

FIG. 4 illustrates the impedances in a first operating state.

FIG. 5 illustrates the impedances in a second operating state.

FIG. 6 illustrates the impedances in a third operating state.

FIG. 7 illustrates the relationship between the output power and the efficiency of the power amplifier circuit during transmission.

FIG. 8 illustrates a configuration of a power amplifier circuit in a radio-frequency module according to a second embodiment and the impedances in a first operating state.

FIG. 9 illustrates the impedances in the power amplifier circuit in FIG. 8 in a second operating state.

FIG. 10 illustrates the impedances in the power amplifier circuit in FIG. 8 in a third operating state.

### DESCRIPTION OF EMBODIMENTS

Hereinafter, embodiments of the present disclosure will be described in detail with reference to the drawings. In the drawings, identical or equivalent parts are denoted by the same reference numerals, and descriptions thereof are omitted.

In the electronic device disclosed in Patent Document 1, coupling of a magnetically coupled transformer is switched between transmission and reception using switches formed of semiconductor devices. In such a configuration, even when the switches are open, radio-frequency signals may partially pass through the switches due to parasitic capacitance inevitably generated in the switches. This may degrade the isolation characteristic between the transmit circuit and the receive circuit. The degradation of the isolation characteristic between the transmit circuit and the receive circuit may increase insertion loss and cause noise.

The present disclosure has been made to solve this problem, and an object thereof is to improve the isolation characteristics between the transmit circuit and the receive circuit in radio-frequency modules that perform transmission and reception using a common antenna.

The radio-frequency module according to the present disclosure can switch between transmission operation and reception operation without incorporating switches for selecting between transmission and reception by appropriately setting the phases of output signals supplied from the amplifier circuits and/or the operating states of the amplifier circuits. Accordingly, in the radio-frequency module designed to perform transmission and reception using a common antenna, the isolation characteristics between the transmit circuit and the receive circuit can be improved.

### First Embodiment

### Overall Configuration of Communication Device

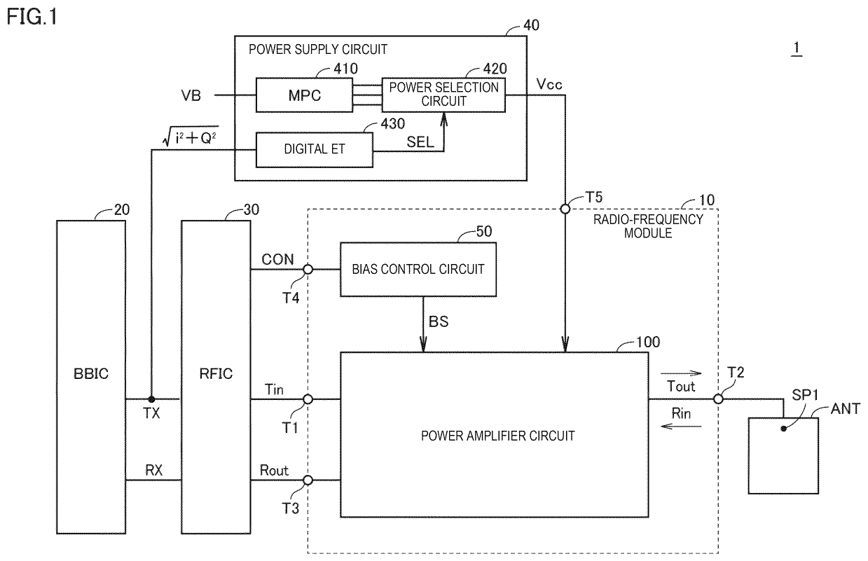

FIG. 1 schematically illustrates a configuration of a communication device 1 including a radio-frequency module 10 according to an embodiment. Examples of the communication device 1 include mobile terminals, such as mobile phones, smartphones, and tablet computers, and personal computers having communication functionality.

Referring to FIG. 1, the communication device 1 includes an antenna ANT, the radio-frequency module 10, a baseband integrated circuit (BBIC) 20 that constitutes a baseband signal processing circuit, a radio frequency integrated circuit (RFIC) 30, and a power supply circuit 40. The radio-frequency module 10 includes terminals T1 to T5, a bias control circuit 50, and a power amplifier circuit 100.

The communication device 1 generally upconverts a transmit signal TX, which is an intermediate-frequency (IF) signal delivered from the BBIC 20, into a radio-frequency (RF) signal by the RFIC 30, amplifies the radio-frequency signal by the power amplifier circuit 100, and emits the radio-frequency signal from the antenna ANT. The communication device 1 also amplifies, with low noise, a radio-frequency signal received through the antenna ANT by the power amplifier circuit 100, downconverts the radio-frequency signal to an intermediate frequency (IF) signal by the RFIC 30, and delivers the IF signal to the BBIC 20 as a receive signal RX.

The RFIC 30 is an example of a signal processing circuit for processing radio-frequency signals. The RFIC 30 upconverts an intermediate-frequency signal delivered from the BBIC 20 into a radio-frequency signal and outputs the generated radio-frequency signal to the radio-frequency module 10 through the terminal T1. The RFIC 30 also receives a radio-frequency signal received by the antenna ANT from the radio-frequency module 10 through the terminal T3.

The bias control circuit 50 receives a control signal CON from the RFIC 30 through the terminal T4. The bias control circuit 50 generates a bias signal BS based on the control signal CON and outputs the bias signal BS to the power amplifier circuit 100. The bias signal BS is a signal for controlling the magnitude of a bias current for amplifiers in the power amplifier circuit 100 and the timing of supplying the bias current.

The power amplifier circuit 100 amplifies an input signal Tin received from the RFIC 30 through the terminal T1 to generate an output signal Tout and outputs the output signal Tout to the antenna ANT. The power amplifier circuit 100 also amplifies a radio-frequency signal Rin received by the antenna ANT to generate an output signal Rout and output the output signal Rout to the RFIC 30 through the terminal T3.

The antenna ANT is, for example, a plate-shaped patch antenna. The terminal T2 of the radio-frequency module 10 is connected to a feed point SP1 of the antenna ANT by a feed line. The antenna ANT emits, as radio waves, the output signal Tout that is a radio-frequency signal output from the radio-frequency module 10. The antenna ANT also receives radio waves from space, converts the radio waves into an electrical signal, and outputs the electrical signal to the RFIC 30.

The power supply circuit 40 is an example of a digital tracker and is configured to supply a supply voltage Vcc having multiple different voltage levels to the power amplifier circuit 100. The power supply circuit 40 includes a multilevel power converter (MPC) 410, a power selection circuit 420, and a digital envelope tracker (digital ET) 430.

The MPC 410 includes multiple DC-DC converters. The MPC 410 converts a battery voltage VB supplied from an external battery into multiple different voltage levels and supplies the voltages to the power selection circuit 420.

The digital ET 430 receives, from the BBIC 20, I and Q waveform signals of the transmit signal and tracks the envelope of the transmit signal in a digital ET mode. The digital ET 430 generates a selection signal SEL corresponding to the voltage level of the envelope of the transmit signal and outputs the selection signal SEL to the power selection circuit 420.

The power selection circuit 420 selects a voltage corresponding to the selection signal SEL from the multiple voltage levels supplied from the MPC 410 and supplies the voltage as the supply voltage Vcc to the power amplifier circuit 100 through the terminal T5.

### Detailed Configuration of Power Amplifier Circuit

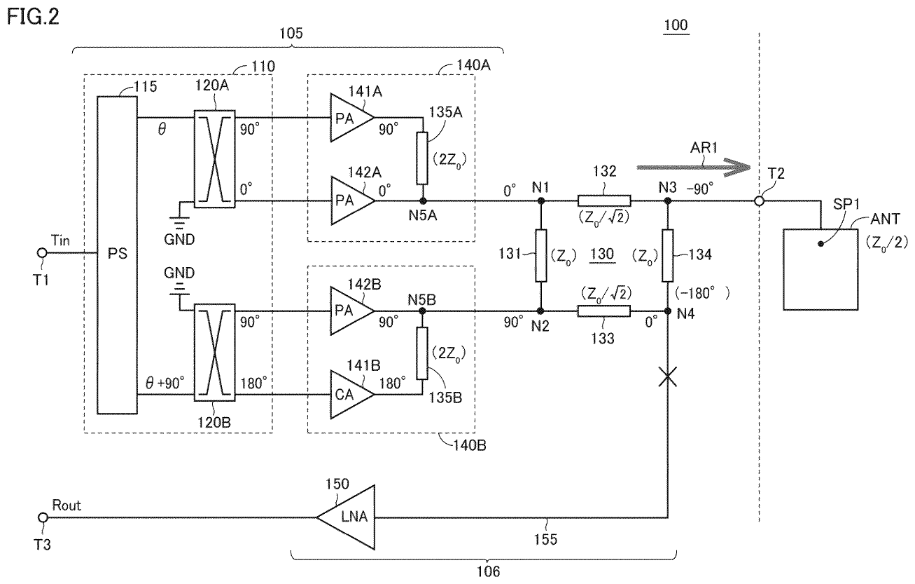

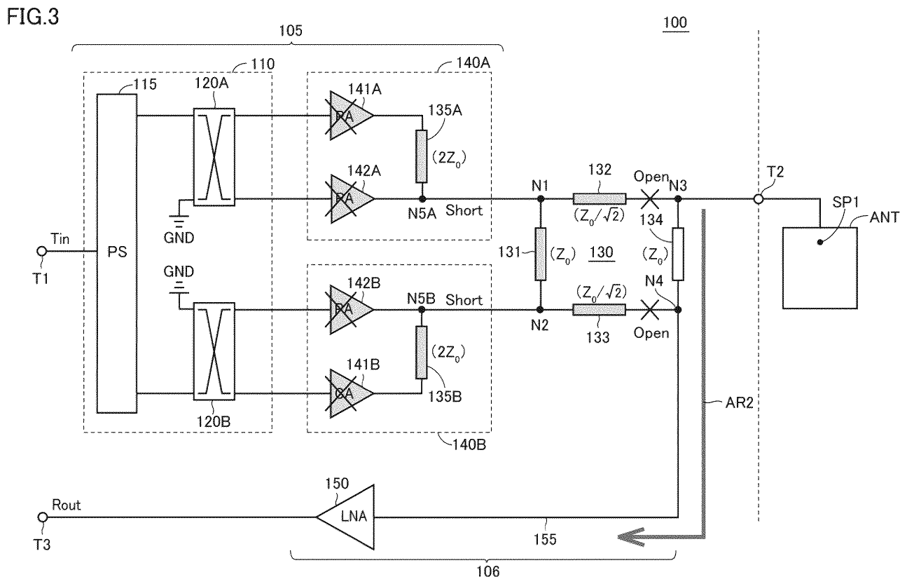

Next, a detailed configuration of the power amplifier circuit 100 in the radio-frequency module 10 is described with reference to FIGS. 2 and 3. FIG. 2 illustrates a configuration of the power amplifier circuit 100 during transmission, and FIG. 3 illustrates a configuration of the power amplifier circuit 100 during reception.

The power amplifier circuit 100 includes a transmit circuit 105, a receive circuit 106, and a hybrid coupler 130. The transmit circuit 105 includes a phase shifter circuit 110 and amplifier circuits 140A and 140B. The receive circuit 106 includes a low-noise amplifier (LNA) 150 and a receive line 155.

The phase shifter circuit 110 includes a branch circuit 115 and hybrid couplers 120A and 120B. The amplifier circuit 140A includes peaking amplifiers 141A and 142A and a phase shift line 135A. The amplifier circuit 140B includes a carrier amplifier 141B, a peaking amplifier 142B, and a phase shift line 135B. The hybrid coupler 130 includes lines 131 to 134 connected in a loop.

The branch circuit 115 splits the input signal Tin received from the RFIC 30 through the terminal T1 into two paths having a phase difference and outputs the split signals respectively to the hybrid couplers 120A and 120B. The hybrid coupler 120B is supplied with a signal having a phase advance of 90° relative to a signal supplied to the hybrid coupler 120A.

The hybrid couplers 120A and 120B each include two input terminals and two output terminals. One input terminal of the hybrid coupler 120A receives a signal from the branch circuit 115. The other input terminal of the hybrid coupler 120A is connected to a ground potential GND. Outputs from the two output terminals of the hybrid coupler 120A are supplied respectively to the peaking amplifier 141A and the peaking amplifier 142A. The peaking amplifier 141A is supplied with a signal having a phase advance of 90° relative to a signal supplied to the peaking amplifier 142A.

One input terminal of the hybrid coupler 120B receives a signal from the branch circuit 115. The other input terminal of the hybrid coupler 120B is connected to a ground potential GND. Outputs from the two output terminals of the hybrid coupler 120B are supplied respectively to the carrier amplifier 141B and the peaking amplifier 142B. The carrier amplifier 141B is supplied with a signal having a phase advance of 90° relative to a signal supplied to the peaking amplifier 142B.

As described above, the hybrid coupler 120B is supplied with a signal having a phase advance of 90° relative to a signal supplied to the hybrid coupler 120A. As a result, the peaking amplifier 142B is supplied with a signal having a phase advance of 90° relative to a signal supplied to the peaking amplifier 142A, while the carrier amplifier 141B is supplied with a signal having a phase advance of 180° relative to a signal supplied to the peaking amplifier 142A.

In the amplifier circuit 140A, one end of the phase shift line 135A is connected to the output terminal of the peaking amplifier 141A, and the other end of the phase shift line 135A is connected to the output terminal of the peaking amplifier 142A. A connection node N5A between the output terminal of the peaking amplifier 142A and the phase shift line 135A is connected to a connection node N1 between the lines 131 and 132 in the hybrid coupler 130. The amplifier circuit 140A also functions as a Doherty amplifier with the peaking amplifier 141A serving as a carrier amplifier and the peaking amplifier 142A serving as a peaking amplifier. As used herein, the term “peaking amplifier” refers to the circuit element's structure, not its functional role in a given operating state. Depending on which amplifiers are active, peaking amplifier 141A may serve as a carrier amplifier in the outer Doherty configuration.

In the amplifier circuit 140B, one end of the phase shift line 135B is connected to the output terminal of the carrier amplifier 141B, and the other end of the phase shift line 135B is connected to the output terminal of the peaking amplifier 142B. A connection node N5B between the output terminal of the peaking amplifier 142B and the phase shift line 135B is connected to a connection node N2 between the lines 131 and 133 in the hybrid coupler 130. The amplifier circuit 140B is a Doherty amplifier.

A connection node N3 between the lines 132 and 134 in the hybrid coupler 130 is connected to the antenna ANT via the terminal T2. A connection node N4 between the lines 133 and 134 in the hybrid coupler 130 is connected to one end of the receive line 155 in the receive circuit 106.

The other end of the receive line 155 is connected to the LNA 150. The receive line 155 delivers a receive signal received by the antenna ANT to the LNA 150. The LNA 150 amplifies, with low noise, the signal delivered through the receive line 155 and outputs the amplified signal as the output signal Rout to the RFIC 30 through the terminal T3.

Each of the lines 131 to 134 in the hybrid coupler 130 and the phase shift lines 135A and 135B in the amplifier circuits has a line length of approximately one-quarter wavelength at the center frequency of a radio-frequency signal to be transmitted from the transmit circuit 105. As a result, after a radio-frequency signal passes through these lines, the phase of the radio-frequency signal is delayed by approximately 90°.

When the load impedance of the antenna ANT is Z₀/2, the impedances of the lines 131 and 134 in the hybrid coupler 130 are Z₀, and the impedances of the lines 132 and 133 are Z₀/√2. The impedances of the phase shift lines 135A and 135B are 2Z₀.

In the amplifier circuit 140A, when both the peaking amplifiers 141A and 142A are active, the signal amplified by the peaking amplifier 141A has a phase advance of 90° relative to the signal amplified by the peaking amplifier 142A. As a result, after passing through the phase shift line 135A, the signal amplified by the peaking amplifier 141A is combined in phase with the signal amplified by the peaking amplifier 142A at the connection node N5A.

Similarly, in the amplifier circuit 140B, when both the carrier amplifier 141B and the peaking amplifier 142B are active, the signal amplified by the carrier amplifier 141B has a phase advance of 90° relative to the signal amplified by the peaking amplifier 142B. As a result, after passing through the phase shift line 135B, the signal amplified by the carrier amplifier 141B is combined in phase with the signal amplified by the peaking amplifier 142B at the connection node N5B. When the phase of the signal output from the amplifier circuit 140A is 0°, the phase of the signal output from the amplifier circuit 140B is 90°.

The signal supplied from the amplifier circuit 140A to the connection node N1 has a phase of −90° at the connection node N3 as a result of passing through the line 132. The signal supplied from the amplifier circuit 140B to the connection node N2 has a phase of −90° at the connection node N3, because the phase is delayed by 180° as a result of passing through the lines 133 and 134. Consequently, at the connection node N3, the signal supplied from the amplifier circuit 140A and the signal supplied from the amplifier circuit 140B are combined in phase.

At the connection node N4, the signal supplied from the amplifier circuit 140A to the connection node N1 has a phase of −180° as a result of passing through the lines 132 and 134. By contrast, the signal supplied from the amplifier circuit 140B to the connection node N2 has a phase of 0° as a result of passing through the line 133. Consequently, at the connection node N4, the signal supplied from the amplifier circuit 140A and the signal supplied from the amplifier circuit 140B are combined in antiphase. Accordingly, the amplitudes of the two signals cancel each other at the connection node N4, resulting in the absence of the input signal Tin.

As described above, during transmission, the input signal Tin input from the RFIC 30 to the power amplifier circuit 100 is delivered through the transmit circuit 105 and the hybrid coupler 130 to the antenna ANT (arrow AR1) without being delivered to the receive circuit 106. Thus, isolation between the transmit circuit 105 and the receive circuit 106 is achieved.

In the case of reception in FIG. 3, the bias control circuit 50 causes the amplifiers in the amplifier circuits 140A and 140B to be inactive. As a result, no signal is supplied from the amplifier circuits 140A and 140B to the hybrid coupler 130, so the input signal Tin is not delivered to the antenna ANT.

In this case, the connection nodes N5A and N5B, which correspond to the output terminals of the amplifier circuits 140A and 140B, are short-circuited. In particular, when the bias current to the amplifiers is removed, the output impedance of each amplifier, as seen from the respective connection node, is substantially a short circuit due to the drain-source or collector-emitter capacitance of the transistor devices being large at the operating frequency, effectively presenting a low impedance to ground. As a result, the impedance seen from the connection node N3 into the line 132 and the impedance seen from the connection node N4 into the line 133 are both open-circuited. Accordingly, the radio-frequency signal received by the antenna ANT is delivered to the receive line 155 and the LNA 150 of the receive circuit 106 through the line 134 in the hybrid coupler 130, as illustrated by the arrow AR2, and is not delivered to the transmit circuit 105. Thus, isolation between the transmit circuit 105 and the receive circuit 106 is achieved.

In recent years, communication in sub-terahertz frequency bands above 100 GHz has been developed for the purpose of large-capacity and high-speed communication. However, signals in this frequency band tend to have greater losses in signal paths than signals in millimeter waves and frequency bands lower than millimeter waves. When the configuration of the power amplifier circuit 100 of the first embodiment is used in communication devices operating in a sub-terahertz frequency band, isolation between the transmit circuit and the receive circuit can be achieved without using active elements such as switches, even when transmission and reception are performed using a common antenna. Thus, isolation between the transmit circuit and the receive circuit can be ensured while insertion loss is reduced.

### Back-Off Level Extension

Signals in higher frequency bands than the frequency bands already used in existing technologies, such as the sub-terahertz frequency bands mentioned above, tend to attenuate more easily than signals in lower frequency bands. For this reason, in power amplifier circuits, it is necessary to cause the supply voltage to follow input-signal changes over a wide modulation band width. To satisfy this requirement, a digital ET mode is usually used in which the supply voltage is set to multiple discrete different voltage levels within a single frame.

As a common amplifier characteristic, efficiency tends to decrease as the input signal decreases. Thus, when the input signal power level decreases due to the digital ET mode, the amplifier efficiency may decrease. By contrast, as another amplifier characteristic, efficiency tends to increase as the load impedance increases. Doherty amplifiers are known as a configuration that improves amplification efficiency by utilizing this characteristic.

A Doherty amplifier has a basic configuration in which a carrier amplifier and a peaking amplifier are coupled in parallel between the input terminal and the output terminal, and in which a phase shift line that functions as an impedance inverter is provided between the carrier amplifier and a combining node. When the output power is relatively small, the carrier amplifier solely operates; when the output power is larger than a predetermined value, both the carrier and peaking amplifiers operate. When the peaking amplifier is inactive, the load impedance of the carrier amplifier increases. Thus, by switching the peaking amplifier between active and inactive in response to changes in the input signal power level caused by the digital ET mode, the Doherty amplifier can achieve a back-off level of approximately 6 dB.

However, the required back-off level for power amplifier circuits can vary depending on, for example, the modulation scheme, the set voltage of the digital ET, and/or the target band width of the digital ET. Depending on the specifications required for the devices in which the power amplifier circuit is used, a back-off level greater than 6 dB may be necessary in certain cases.

In the power amplifier circuit 100 of the first embodiment, the amplifier circuits 140A and 140B each have a Doherty amplifier configuration. Thus, a back-off level of 6 dB can be achieved by setting the peaking amplifier 142A in the amplifier circuit 140A and the peaking amplifier 142B in the amplifier circuit 140B inactive.

When the peaking amplifiers 142A and 142B are inactive, another Doherty amplifier is constituted by the carrier amplifier 141B of the amplifier circuit 140B, the peaking amplifier 141A of the amplifier circuit 140A, and the line 131 of the hybrid coupler 130. Accordingly, by setting the peaking amplifier 141A of the amplifier circuit 140A inactive, a back-off level of 15 dB can be achieved. In this configuration, line 131 of the hybrid coupler 130 functions as an impedance inverter, such that the carrier amplifier 141B, the peaking amplifier 141A, and the line 131 together constitute a Doherty amplifier having a load modulation characteristic.

In the power amplifier circuit 100 of the first embodiment, Doherty amplifiers are constituted respectively by the two amplifier circuits 140A and 140B, and another Doherty amplifier is constituted by the amplifier circuits 140A and 140B and the hybrid coupler 130. By configuring Doherty amplifiers in two stages in this manner, a back-off level greater than 6 dB can be achieved.

### Transmit Circuit Operation

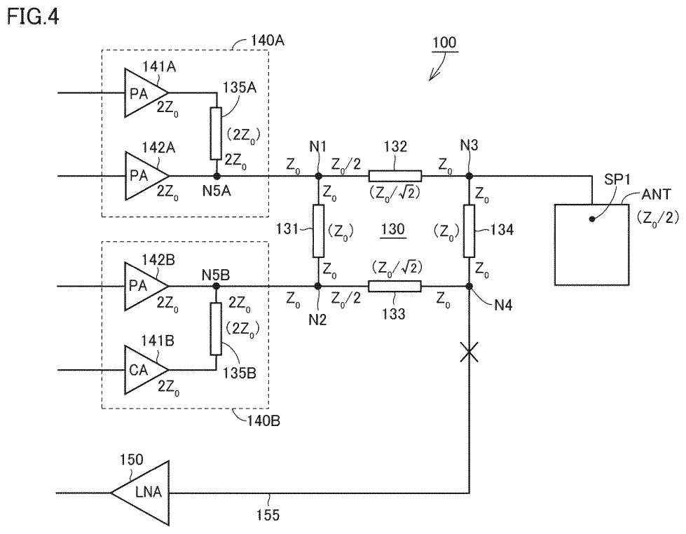

In the following, the operation of the transmit circuit 105 during transmission is described in detail with reference to FIGS. 4 to 7. FIGS. 4 to 6 illustrate the impedance in the circuit in different operating states of the transmit circuit 105. In FIGS. 4 to 6, the phase shifter circuit 110 in the transmit circuit 105 is omitted.

The operating state of the transmit circuit 105 varies in response to the supply voltage Vcc. In the example of the first embodiment, the supply voltage Vcc is switched among three levels, V1, V2, V3 (V3<V2<V1), by digital ET. The case of Vcc=V1 is defined as a first operating state, Vcc=V2 is defined as a second operating state, and Vcc=V3 is defined as a third operating state. The supply voltage Vcc is set by the digital ET in correspondence with the power level of the input signal Tin. Specifically, V1 corresponds to a power level greater than or equal to a first threshold, V2 corresponds to a power level between a first threshold and a second threshold, and V3 corresponds to a power level below the second threshold.

The first operating state (FIG. 4) corresponds to a state in which the power level of the input signal Tin is greater than a first power value. In the first operating state, since a relatively large amount of power is required, the peaking amplifiers 141A, 142A, and 142B are all active, and a total of four amplifiers, including the carrier amplifier 141B, are used for amplification.

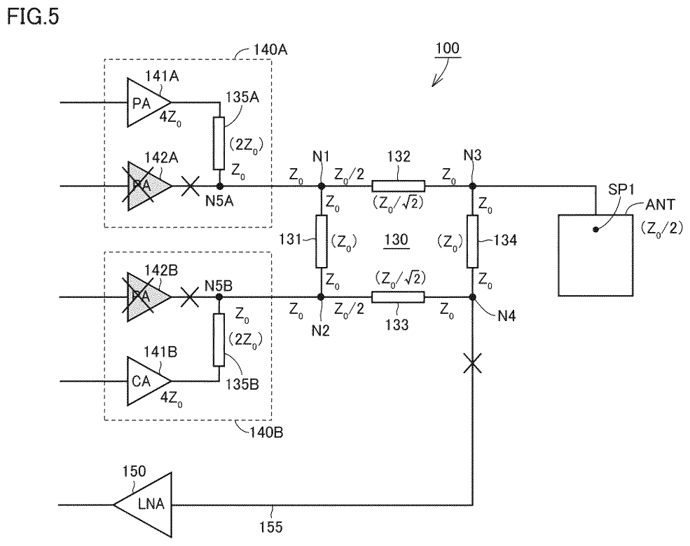

The second operating state (FIG. 5) corresponds to a state in which the power level of the input signal Tin is a second power value that is smaller than the first power value. In the second operating state, the peaking amplifiers 142A and 142B are inactive, while the peaking amplifier 141A is active. In other words, amplification is performed by the peaking amplifier 141A of the amplifier circuit 140A and the carrier amplifier 141B of the amplifier circuit 140B.

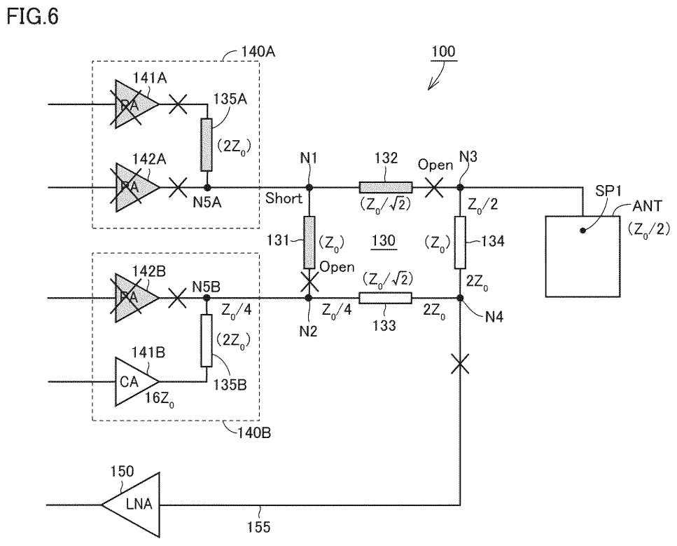

The third operating state (FIG. 6) corresponds to a state in which the power level of the input signal Tin is a third power value that is still smaller than the second power value. In the third operating state, the peaking amplifiers 141A, 142A, and 142B are inactive, and the carrier amplifier 141B is solely used for amplification.

FIG. 4 illustrates the impedances in the power amplifier circuit 100 in the first operating state. As illustrated in FIG. 2, when the load impedance of the antenna ANT is Z₀/2, the impedances of the lines 131 and 134 in the hybrid coupler 130 are Z₀, and the impedances of the lines 132 and 133 are Z₀/√2. The impedances of the phase shift lines 135A and 135B are 2Z₀.

Because the signal path branches in two directions at the connection node N3, the load impedance seen from the branch leading to the line 132 and the load impedance seen from the branch leading to the line 134 are both Z₀.

Because the impedance of the line 132 is Z₀/√2, the impedance seen from the connection node N1 into the line 132 is Z₀/2. Because the signal path branches in two directions at the connection node N1, the load impedance seen from the branch leading to the amplifier circuit 140A and the load impedance seen from the branch leading to the line 131 are both Z₀.

In the amplifier circuit 140A, the signal path branches in two directions at the connection node N5A, and the impedance of the phase shift line 135A is set to 2Z₀. As a result, the impedance seen from the output terminals of the peaking amplifiers 141A and 142A toward the load is 2Z₀.

The impedance of the line 134 of the hybrid coupler 130 is set to Z₀, so the impedance seen from the connection node N4 into the line 134 is also Z₀. As described above, because no signal is delivered from the connection node N4 to the receive line 155, which is practically open-circuited, the load impedance seen from the branch leading to the line 133 into the connection node N4 is maintained at Z₀.

As a result, the impedance seen from the output terminals of the carrier amplifier 141B and the peaking amplifier 142B toward the load is 2Z₀, similar to the path on the amplifier circuit 140A side.

FIG. 5 illustrates the impedances in the power amplifier circuit 100 in the second operating state. In the second operating state, the peaking amplifier 142A in the amplifier circuit 140A and the peaking amplifier 142B in the amplifier circuit 140B are inactive. Accordingly, the impedance seen from the connection node N5A into the peaking amplifier 142A and the impedance seen from the connection node N5B into the peaking amplifier 142B are open-circuited.

As a result, the impedance seen from the branch leading to the phase shift line 135A toward the load and the impedance seen from the branch leading to the phase shift line 135B toward the load are both Z₀. Because the impedances of the phase shift lines 135A and 135B are 2Z₀, the impedances seen from the output terminals of the peaking amplifier 141A and the carrier amplifier 141B toward the load are 4Z₀.

As described above, in the second operating state, compared to the first operating state, the number of amplifiers is halved, while the load impedance of the amplifiers in operation is doubled. As a result, a back-off level of 6 dB can be achieved.

FIG. 6 illustrates the impedances in the power amplifier circuit 100 in the third operating state. In the third operating state, in addition to the configuration in the second operating state, the peaking amplifier 141A of the amplifier circuit 140A is inactive. As a result, the impedance seen from the phase shift line 135A into the peaking amplifier 141A is open-circuited, and as a result, the impedance at the connection node N1 is short-circuited. As a result, the impedance seen from the connection node N2 into the line 131 and the impedance seen from the connection node N3 into the line 132 are open-circuited.

The impedance at the branch leading from the connection node N3 to the line 134 is Z₀/2, the impedance at the connection node N4 is 2Z₀, and the impedances at the connection nodes N2 and N5B are Z₀/4. The impedance Z₀/4 at connection node N2, when transformed through the phase shift line 135B having an impedance of 2Z₀ and a length of one-quarter wavelength, yields an impedance of (2Z₀)²/(Z₀/4)=16Z₀ at the output terminal of the carrier amplifier 141B. Overall, in the third operating state, the impedance of the carrier amplifier 141B is quadrupled compared to the second operating state.

As described above, in the third operating state, compared to the second operating state, the number of amplifiers is further halved, while the load impedance of the amplifiers in operation is quadrupled. As a result, a higher back-off level of 9 dB can be achieved. Accordingly, compared to the first operating state, a total back-off level of 15 dB can be achieved.

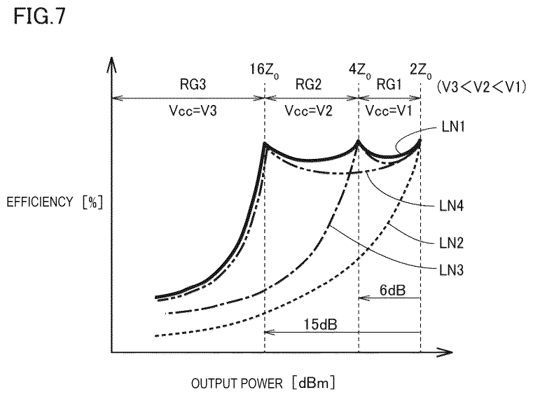

FIG. 7 illustrates the relationship between the output power and the efficiency of the power amplifier circuit 100 during transmission.

In FIG. 7, the horizontal axis represents the power level of the output signal Tout from the terminal T2 to the antenna ANT, and the vertical axis represents the efficiency of the power amplifier circuit 100.

In FIG. 7, the dashed line LN2 is a graph corresponding to the first operating state, in which the peaking amplifiers 141A, 142A, and 142B and the carrier amplifier 141B are active. In this example, four Class-AB amplifiers corresponding to the peaking amplifiers 141A, 142A, and 142B and the carrier amplifier 141B are active in an average power tracking (APT) mode. In the APT mode, the supply voltage level is set based on the average output power over a given period.

The dot-dash line LN3 illustrates the graph obtained when the operating state is switched between the second operating state, in which the peaking amplifier 141A and the carrier amplifier 141B are active while the peaking amplifiers 142A and 142B are inactive, and the first operating state. The two-dot chain line LN4 illustrates the graph obtained when the operating state is switched between the third operating state, in which the carrier amplifier 141B is solely active while the peaking amplifiers 141A, 142A, and 142B are inactive, and the first operating state. The solid line LN1 illustrates the graph obtained when the operating state is switched among the first operating state, the second operating state, and the third operating state based on the power level of the input signal Tin, as in the first embodiment.

The region until the amplifiers are saturated in the third operating state is denoted as RG3. The region until the amplifiers are saturated in the second operating state is denoted as RG2. The region until the amplifiers are saturated in the first operating state is denoted as RG1. The supply voltage Vcc in the first operating state is set to V1. The supply voltage Vcc in the second operating state is set to V2. The supply voltage Vcc in the third operating state is set to V3 (V1>V2>V3).

In the region RG1, the parallel operation of the two amplifiers included in each of the two Doherty amplifiers, implemented by the amplifier circuits 140A and 140B, improves efficiency compared to the case of Class-AB amplifiers (the dashed line LN2).

In the region RG2, in which the power level of the input signal Tin decreases from the first power value to the second power value, as illustrated in FIG. 5, the peaking amplifier 142A in the amplifier circuit 140A and the peaking amplifier 142B in the amplifier circuit 140B are set inactive, so that the impedances of the peaking amplifier 141A and the carrier amplifier 141B, which are active, increase. Accordingly, the efficiency of each amplifier increases.

In the region RG3, in which the power level of the input signal Tin decreases to the third power value, the peaking amplifier 141A of the amplifier circuit 140A is set inactive, so that the impedance of the carrier amplifier 141B, which is active, further increases. As such, the efficiency of the carrier amplifier 141B is increased.

In the power amplifier circuit 100 of the first embodiment, a back-off level of 15 dB can be achieved by setting some amplifiers inactive as the power level of the input signal Tin decreases.

As described above, a configuration is used in which two amplifier circuits are connected to two input terminals of a hybrid coupler, and two output terminals of the hybrid coupler are connected to the antenna and the receive circuit. This configuration can achieve isolation between the transmit circuit and the receive circuit while avoiding decreases in loss caused by switches.

Furthermore, two amplifier circuits in the transmit circuit are configured as Doherty amplifiers, and some amplifiers in the amplifier circuits are set inactive as the input signal power level decreases. This configuration can achieve a back-off level greater than 6 dB.

“The amplifier circuit 140A”, “the amplifier circuit 140B”, and “the LNA 150” in the first embodiment respectively correspond to “a first amplifier circuit”, “a second amplifier circuit”, and “a third amplifier circuit” in the present disclosure. “The terminals T1 to T3” in the first embodiment respectively correspond to “a first terminal”, “a second terminal”, and “a third terminal” in the present disclosure. “The lines 131 to 134” in the first embodiment respectively correspond to “a first line” to “a fourth line” in the present disclosure. “The connection node N1” to “the connection node N4” in the first embodiment respectively correspond to “a first connection node” to “a fourth connection node” in the present disclosure. “The peaking amplifier 141A”, “the peaking amplifier 142A”, “the carrier amplifier 141B”, and “the peaking amplifier 142B” in the first embodiment respectively correspond to “a first amplifier” to “a fourth amplifier” in the present disclosure. “The phase shift line 135A” and “the phase shift line 135B” in the first embodiment respectively correspond to “a first phase shift line” and “a second phase shift line” in the present disclosure.

### Second Embodiment

In the first embodiment, a configuration in which two amplifier circuits in a transmit circuit are directly connected to an input terminal of a hybrid coupler is described. In the second embodiment, a configuration in which two amplifier circuits in a transmit circuit are connected to a hybrid coupler via transformers is described. The first embodiment corresponds to a configuration in which signals from two amplifier circuits are combined as current. By contrast, the configuration of the second embodiment using transformers corresponds to a configuration in which two signals are combined as voltage.

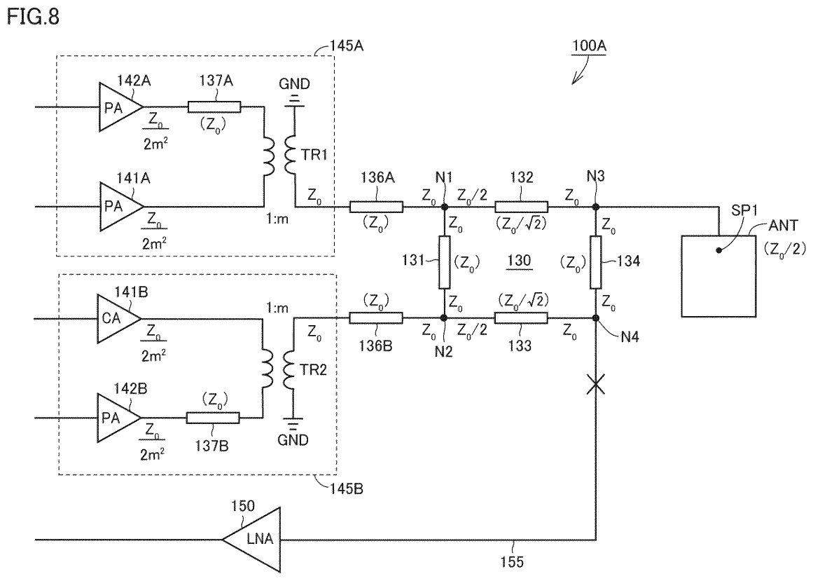

FIGS. 8 to 10 illustrate the configuration of a power amplifier circuit 100A in a radio-frequency module according to the second embodiment and the impedances in different operating states. FIGS. 8 to 10 correspond to FIGS. 4 to 6 in the first embodiment. Also in FIGS. 8 to 10, a phase shifter circuit 110 is omitted.

Referring to FIG. 8, the power amplifier circuit 100A has a configuration in which amplifier circuits 145A and 145B and phase shift lines 136A and 136B are provided instead of the amplifier circuits 140A and 140B of the power amplifier circuit 100 in the first embodiment.

The amplifier circuit 145A includes peaking amplifiers 141A and 142A, a phase shift line 137A, and a transformer TR1. The amplifier circuit 145B includes a carrier amplifier 141B, a peaking amplifier 142B, a phase shift line 137B, and a transformer TR2.

The transformers TR1 and TR2 are isolation transformers having a primary-to-secondary winding ratio of 1:m. In certain embodiments, the winding ratio m may be selected such that Z₀/2m² matches a desired output impedance of the amplifiers in the amplifier circuits 145A and 145B, for example m=1 for unity impedance transformation or m>1 for impedance step-down. One end of the primary winding of the transformer TR1 is connected to the output terminal of the peaking amplifier 141A. The other end of the primary winding of the transformer TR1 is connected to the output terminal of the peaking amplifier 142A via the phase shift line 137A. One end of the secondary winding of the transformer TR1 is connected to a connection node N1 in a hybrid coupler 130 via the phase shift line 136A. The other end of the secondary winding of the transformer TR1 is connected to a ground potential GND.

One end of the primary winding of the transformer TR2 is connected to the output terminal of the carrier amplifier 141B. The other end of the primary winding of the transformer TR2 is connected to the output terminal of the peaking amplifier 142B via the phase shift line 137B. One end of the secondary winding of the transformer TR2 is connected to a connection node N2 in the hybrid coupler 130 via the phase shift line 136B. The other end of the secondary winding of the transformer TR2 is connected to a ground potential GND.

Each of the phase shift lines 136A, 136B, 137A, and 137B has a line length of approximately one-quarter wavelength at the center frequency of a radio-frequency signal to be transmitted. When the load impedance of the antenna ANT is Z₀/2, the impedance of each phase shift line is Z₀.

In a first operating state (FIG. 8), all the amplifiers in the amplifier circuits 145A and 145B are set active. In this case, the load impedance at the branch from the connection node N1 to the phase shift line 136A and the load impedance at the branch from the connection node N2 to the phase shift line 136B are both Z₀. Accordingly, the impedances seen from the secondary windings of the transformers TR1 and TR2 toward the load are also Z₀. Because the winding ratio of the transformers TR1 and TR2 is 1:m, the impedances seen from the output terminals of the amplifiers in the amplifier circuits 145A and 145B toward the load are Z₀/2m².

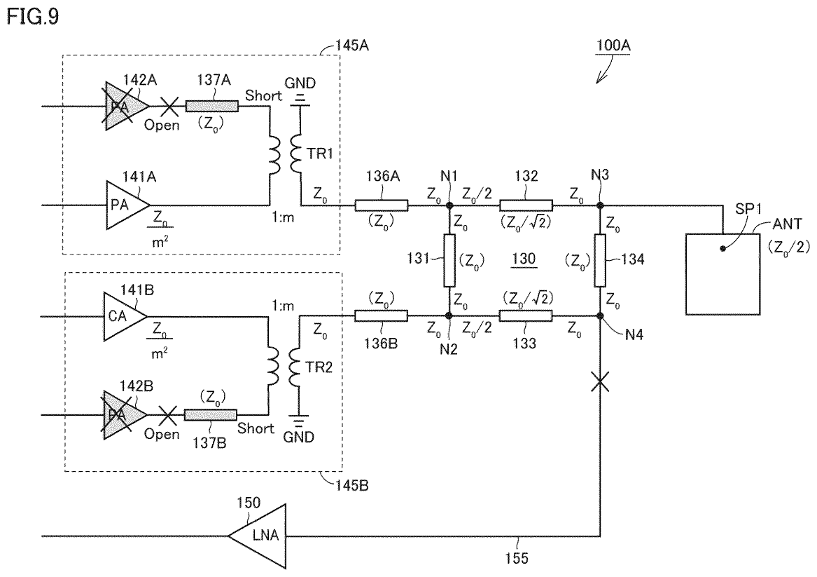

In a second operating state (FIG. 9), the peaking amplifier 142A in the amplifier circuit 145A and the peaking amplifier 142B in the amplifier circuit 145B are inactive. As a result, the impedances at the output terminals of the peaking amplifiers 142A and 142B are open-circuited, so the connection node between the phase shift line 137A and the primary winding of the transformer TR1 and the connection node between the phase shift line 137B and the primary winding of the transformer TR2 are short-circuited. Accordingly, the impedance seen from the output terminal of the peaking amplifier 141A in the amplifier circuit 145A toward the load and the impedance seen from the output terminal of the carrier amplifier 141B in the amplifier circuit 145B toward the load are Z₀/m².

In the second operating state, compared to the first operating state, the number of amplifiers is halved, while the load impedance of the amplifiers in operation is doubled. As a result, a back-off level of 6 dB can be achieved.

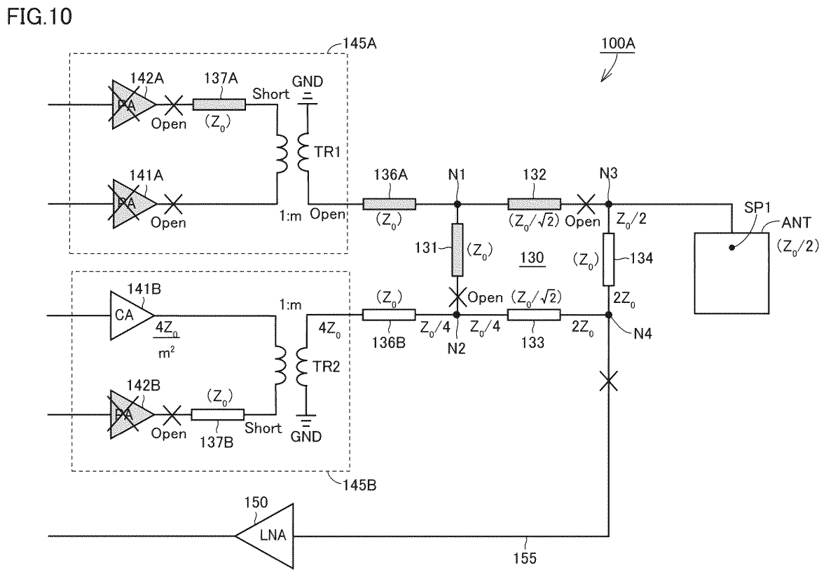

In a third operating state (FIG. 10), in addition to the configuration in the second operating state, the peaking amplifier 141A of the amplifier circuit 145A is inactive. This means that the entire amplifier circuit 145A is inactive, and the impedance at the output terminal of the amplifier circuit 145A is open-circuited. As a result, the impedance at the connection node N1 is short-circuited, so the impedance seen from the connection node N2 into the line 131 and the impedance seen from the connection node N3 into the line 132 are both open-circuited.

In this state, similar to the case of the first embodiment, the load impedance at the connection node N2 is Z₀/4, so the phase shift line 136B causes the load impedance at the secondary winding of the transformer TR2 to become 4Z₀. As a result, the impedance seen from the output terminal of the carrier amplifier 141B toward the load is 4Z₀/m², which is four times the corresponding impedance in the second operating state.

In the third operating state, compared to the second operating state, the number of amplifiers is halved, while the load impedance of the amplifiers in operation is quadrupled. As a result, a higher back-off level of 9 dB can be achieved. As a result, a total back-off level of 15 dB can be achieved.

As described above, also in a configuration in which signals are combined as voltage using transformers as described in the second embodiment, two amplifier circuits are connected to two input terminals of a hybrid coupler, and two output terminals of the hybrid coupler are connected to the antenna and the receive circuit. This configuration can achieve isolation between the transmit circuit and the receive circuit while avoiding decreases in loss caused by switches. Furthermore, Doherty amplifiers are constituted by respective amplifier circuits, and another Doherty amplifier is constituted by the two amplifier circuits and a hybrid coupler. This configuration can achieve a back-off level greater than 6 dB.

“The phase shift line 136A”, “the phase shift line 136B”, “the phase shift line 137A”, and “the phase shift line 137B” in the second embodiment respectively correspond to “a third phase shift line” to “a sixth phase shift line” in the present disclosure. “The transformer TR1” and “the transformer TR2” in the second embodiment respectively correspond to “a first transformer” and “a second transformer” in the present disclosure.

The embodiments disclosed herein should be considered as examples in all respects and should not be interpreted as limiting. The scope of the present disclosure is indicated by the claims rather than the above descriptions of the embodiments, and all changes that come within the meaning and range of equivalency of the claims are therefore intended to be embraced therein.

### REFERENCE SIGNS LIST

1 communication device, 10 radio-frequency module, 20 BBIC, 30 RFIC, 40 power supply circuit, 50 bias control circuit, 100, 100A power amplifier circuit, 105 transmit circuit, 106 receive circuit, 110 phase shifter circuit, 115 branch circuit, 120A, 120B, 130 hybrid coupler, 131-134 line, 135A-137A, 135B-137B phase shift line, 140A, 140B, 145A, 145B amplifier circuit, 141A, 142A, 142B peaking amplifier, 141B carrier amplifier, 150 LNA, 155 receive line, 410 MPC, 420 power selection circuit, 430 digital ET, ANT antenna, GND ground potential, N1-N4, N5A, N5B connection node, RG1-RG3 region, SP1 feed point, T1-T5 terminal, TR1, TR2 transformer, VB battery voltage, Vcc supply voltage

1. A radio-frequency module, comprising:
a first terminal configured to receive a transmit signal;
a second terminal configured to be connected to an antenna;
a third terminal configured to output a radio-frequency signal received from the antenna;
a transmit circuit including a first amplifier circuit and a second amplifier circuit, the first amplifier circuit and the second amplifier circuit being configured to amplify a signal received through the first terminal;
a receive circuit including a receive line configured to deliver a signal received by the antenna to the third terminal; and
a hybrid coupler connected to the transmit circuit, the receive circuit, and the second terminal, wherein
the hybrid coupler includes a first line, a second line, a third line, and a fourth line connected in a loop,
a first connection node between the first line and the second line is connected to an output terminal of the first amplifier circuit,
a second connection node between the first line and the third line is connected to an output terminal of the second amplifier circuit,
a third connection node between the second line and the fourth line is connected to the second terminal, and
a fourth connection node between the third line and the fourth line is connected to the receive line.

2. The radio-frequency module according to claim 1, wherein
the transmit circuit is configured to, when a signal is to be transmitted from the antenna, supply to the second connection node a signal having a phase advance of 90°relative to a signal supplied to the first connection node, and
the transmit circuit is configured to, when a signal is received from the antenna, be set inactive.

3. The radio-frequency module according to claim 1, wherein
the receive circuit further includes a third amplifier circuit configured to amplify a signal from the receive line and to output the signal to the third terminal.

4. The radio-frequency module according to claim 3, wherein the third amplifier circuit is a low-noise amplifier.

5. The radio-frequency module according to claim 1, wherein
the first amplifier circuit is a Doherty amplifier including a first amplifier, a second amplifier, and a first phase shift line connected between an output terminal of the first amplifier and an output terminal of the second amplifier,
the second amplifier circuit is a Doherty amplifier including a third amplifier, a fourth amplifier, and a second phase shift line connected between an output terminal of the third amplifier and an output terminal of the fourth amplifier,
the output terminal of the second amplifier is connected to the first connection node, and
the output terminal of the fourth amplifier is connected to the second connection node.

6. The radio-frequency module according to claim 5, further comprising a bias control circuit configured to selectively set the second amplifier and the fourth amplifier inactive when an output power level falls below a first threshold.

7. The radio-frequency module according to claim 6,
wherein the bias control circuit is configured to set first the first amplifier inactive when the output power level falls below a second threshold that is lower than the first threshold.

8. The radio-frequency module according to claim 5, wherein
the transmit circuit further includes a phase shifter circuit configured to supply the transmit signal received through the first terminal to the first amplifier circuit and the second amplifier circuit with a phase difference, and
the phase shifter circuit is configured to, when a signal is to be transmitted from the antenna,
supply to the first amplifier and the fourth amplifier a signal having a phase advance of 90° relative to a signal supplied to the second amplifier, and
supply to the third amplifier a signal having a phase advance of 180° relative to the signal supplied to the second amplifier.

9. The radio-frequency module according to claim 8, further comprising a bias control circuit configured to:
when a power level of the transmit signal is greater than or equal to a first threshold, set the first amplifier, the second amplifier, the third amplifier, and the fourth amplifier active, and
when the power level of the transmit signal is less than the first threshold and greater than or equal to a second threshold, set the first amplifier and the third amplifier active and set the second amplifier and the fourth amplifier inactive, and
when the power level of the transmit signal is less than the second threshold, set the third amplifier active and set the first amplifier, the second amplifier, and the fourth amplifier inactive.

10. The radio-frequency module according to claim 5, wherein
when a signal is received from the antenna, the first amplifier to the fourth amplifier are all set inactive.

11. The radio-frequency module according to claim 5, wherein the transmit circuit further includes a phase shifter circuit configured to supply the transmit signal to the first amplifier circuit and the second amplifier circuit with a 90-degree phase difference, such that a signal supplied to the second connection node has a phase advance of 90 degrees relative to a signal supplied to the first connection node during transmission.

12. The radio-frequency module according to claim 1, further comprising:
a third phase shift line connected between the output terminal of the first amplifier circuit and the first connection node; and
a fourth phase shift line connected between the output terminal of the second amplifier circuit and the second connection node, wherein
the first amplifier circuit includes a first amplifier, a second amplifier, a fifth phase shift line, and a first transformer,
the second amplifier circuit includes a third amplifier, a fourth amplifier, a sixth phase shift line, and a second transformer,
one end of a primary winding of the first transformer is connected to an output terminal of the first amplifier, and another end of the primary winding of the first transformer is connected to an output terminal of the second amplifier via the fifth phase shift line,
one end of a secondary winding of the first transformer is connected to the third phase shift line, and another end of the secondary winding of the first transformer is connected to a ground potential,
one end of a primary winding of the second transformer is connected to an output terminal of the third amplifier, and another end of the primary winding of the second transformer is connected to an output terminal of the fourth amplifier via the sixth phase shift line, and
one end of a secondary winding of the second transformer is connected to the fourth phase shift line, and another end of the secondary winding of the second transformer is connected to the ground potential.

13. The radio-frequency module according to claim 1, further comprising a power supply circuit configured to supply a supply voltage having a plurality of discrete voltage levels to the first amplifier circuit and the second amplifier circuit, the supply voltage being selected based on an envelope of the transmit signal.

14. The radio-frequency module according to claim 1, wherein each of the first line, the second line, the third line, and the fourth line of the hybrid coupler has a line length of approximately one-quarter wavelength at a center frequency of a radio-frequency signal to be transmitted.

15. The radio-frequency module according to claim 1, wherein an impedance of each of the first line and the fourth line is Z0, an impedance of each of the second line and the third line is Z0 divided by the square root of 2, and a load impedance of the antenna is Z0 divided by 2, wherein Z0 is a characteristic impedance.

16. The radio-frequency module according to claim 1, wherein the radio-frequency module is configured to operate in a sub-terahertz frequency band above 100 GHz.

17. A communication device comprising:
the radio-frequency module according to claim 1;
the antenna; and
a signal processing circuit configured to process the transmit signal, the transmit signal being to be supplied to the radio-frequency module, and a receive signal received by the antenna.

18. A method of operating a radio-frequency module that includes a first terminal, a second terminal connected to an antenna, a third terminal, a transmit circuit having a first amplifier circuit and a second amplifier circuit, a receive circuit having a receive line, and a hybrid coupler having first, second, third, and fourth lines connected in a loop with a first connection node connected to an output of the first amplifier circuit, a second connection node connected to an output of the second amplifier circuit, a third connection node connected to the second terminal, and a fourth connection node connected to the receive line, the method comprising:
during transmission, activating the first amplifier circuit and the second amplifier circuit and supplying to the second connection node a signal having a phase advance of 90 degrees relative to a signal supplied to the first connection node, so that signals combine in phase at the third connection node and cancel at the fourth connection node; and
during reception, deactivating the first amplifier circuit and the second amplifier circuit, so that a radio-frequency signal received by the antenna is delivered through the fourth line to the receive line.

19. The method according to claim 18, further comprising:
adjusting a supply voltage to the first amplifier circuit and the second amplifier circuit among a plurality of discrete voltage levels based on an envelope of the transmit signal.

20. The radio-frequency module according to claim 1, further comprising generating a bias signal that controls a magnitude of a bias current and a timing of supplying the bias current to the first amplifier circuit and the second amplifier circuit.
